(19) United States
(12) Patent Application Publication
(10) Pub. No.: US 2025/0103951 A1
(43) Pub. Date: Mar. 27, 2025

(54) Machine learning using a diffusion model for out-of-distribution detection of time series data

(71) Applicant: Zscaler, Inc., San Jose, CA (US)

(72) Inventors: Dianhuan Lin, San Jose, CA (US); Shubhankar Agarwal, Austin, TX (US); Hanchen Xiong, London (GB); Zicun Cong, Burnaby (CA); Aakarshan Chauhan, Bangalore (IN); Janmey Sandeep Shukla, Bangalore (IN)

(73) Assignee: Zscaler, Inc., San Jose, CA (US)

(21) Appl. No.: 18/507,417

(22) Filed: Nov. 13, 2023

(30) Foreign Application Priority Data
Sep. 27, 2023 (IN) 202341064803

(51) Int. Cl. G06N 20/00

(52) U.S. Cl. CPC G06N 20/00

(57) ABSTRACT

Systems and methods for using a diffusion machine learning model for out-of-distribution (OOD) detection of time series data include steps of receiving an input time series; causing random imputations in the input time series to provide an imputed time series; processing the imputed time series with a diffusion model that has been parameterized on a given in-distribution time series to obtain a reconstructed time series; and comparing the reconstructed time series with the input time series to determine whether the input time series is out-of-distribution with the in-distribution time series. In particular, the present disclosure includes a novel approach for using a diffusion model of OOD detection which does not require labels for OOD data.

### FIELD OF THE DISCLOSURE

The present disclosure generally relates to machine learning techniques implemented via a computer. More particularly, the present disclosure relates to systems and methods for using a diffusion machine learning model for out-of-distribution detection of time series data.

### BACKGROUND OF THE DISCLOSURE

Machine learning techniques are proliferating and offer many use cases, especially in network and computer security (which are referred to herein as simply network security). In network security, use cases for machine learning include malware detection, identifying malicious files for further processing such as in a sandbox, user or content risk determination, intrusion detection, behavior analysis and classification, etc. Of course, machine learning is useful in other areas as well, such as, e.g., medicine, criminal justice, financial analysis, weather forecasting, and the like.

Machine learning models need to identify user inputs that are out-of-distribution (OOD) so as to avoid performing wrong actions. The process of OOD detection involves determining if a given data point is part of a specific distribution or domain. This is crucial because machine learning models generally presume that samples at test-time are derived from the same distribution as the training data. If the test data deviates from the training distribution, it may lead to illogical outcomes. For instance, if a financial analyst inadvertently inputs stock market data into a weather forecasting model, the model would likely generate an illogical and potentially misleading prediction about future climate conditions.

### BRIEF SUMMARY OF THE DISCLOSURE

The present disclosure relates to systems and methods for using a diffusion machine learning model for out-of-distribution detection of time series data. Previous studies have explored OOD detection in various contexts, including supervised and unsupervised settings. In supervised scenarios, guidance can be obtained from multiple sources. The most well-informed approach assumes access to representative out-of-distribution samples, enabling the training of an OOD detector as a classifier that distinguishes between in-distribution and out-of-distribution data, resulting in high performance-provided the OOD data remains consistent with the assumed OOD distribution. However, in many real-world applications, such information is unobtainable, as OOD data can be quite diverse and unpredictable.

A considerably more lenient assumption is to only require access to an in-distribution classifier or class labels. Under this framework, approaches have demonstrated competitive results. Although this approach is less informed, it depends on two implicit assumptions: that the in-distribution data has well-defined classes and that there is an ample amount of data with class annotations. In reality, these conditions are often not met. Unlabeled data, which does not necessitate costly human annotation, is typically available in large quantities. Ideally, an OOD detector should only need unlabeled in-distribution data during the training process.

In the present disclosure, we propose that by utilizing the characteristic of a diffusion model, which learns a mapping to a manifold, we can develop a powerful unsupervised OOD detector. The underlying concept is that when an image is elevated from its manifold, the diffusion model trained on the same manifold can restore the image to its original vicinity. Conversely, if the diffusion model is trained on a distinct manifold, it will attempt to map the elevated image toward its own training manifold, resulting in a significant distance between the original and mapped images. Consequently, we can identify out-of-distribution images by examining this distance.

In various embodiments, the present disclosure includes a method having steps, a processing device configured to implement the steps, a cloud service configured to implement the steps, and a non-transitory computer-readable medium storing instructions for programming one or more processors to execute the steps. The steps include receiving an input time series; causing random imputations in the input time series to provide an imputed time series; processing the imputed time series with a diffusion model that has been parameterized on a given in-distribution time series to obtain a reconstructed time series; and comparing the reconstructed time series with the input time series to determine whether the input time series is out-of-distribution with the in-distribution time series.

The comparing can include determining a score based on distance between the reconstructed time series and the input time series, wherein the score is an indicator of a likelihood the input time series is out-of-distribution. The distance can be one of Euclidean distance and cosine similarity. When the input time series is out-of-distribution, the reconstructed time series is a bad reconstruction relative to when the input time series is in-distribution. The processing can further include utilizing domain-specific side information with the imputed time series in the diffusion model. The random imputations can be performed using a mask determined based on a number of time steps and a number of features.

The steps can further include training the diffusion model with in-distribution time series data, such that the comparing determines whether or not the input time series belongs to a same distribution as the in-distribution time series data. The steps can further include classifying the input time series based on the comparing such that (1) when the input time series is in-distribution, the input time series is classified as belonging to a domain associated with the in-distribution time series, and (2) when the input time series is out-of-distribution, the input time series is classified as not belonging to the domain. The steps can further include determining whether the input time series is anomalous Internet of Things (IoT) communications based on the comparing. The steps can further include determining whether the input time series corresponds to a Distributed Denial of Service (DDoS) network flow based on the comparing.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of an unsupervised OOD detection system.

FIG. 2 is a flowchart of a process for unsupervised OOD detection.

FIG. 3 is a process for using a diffusion machine learning model OOD detection of time series data.

FIG. 4 is a block diagram of a processing system.

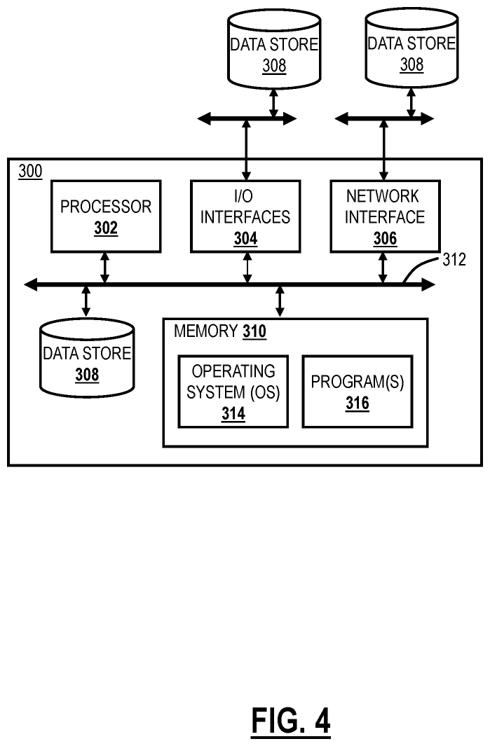

### DETAILED DESCRIPTION OF THE DISCLOSURE

Again, the present disclosure relates to systems and methods for using a diffusion machine learning model for out-of-distribution detection of time series data.

### Diffusion Models

Diffusion models represent a class of generative models that demonstrate state-of-the-art performance on a range of different data modalities, e.g., image, speech, video, etc. Of note, conventionally, diffusion models are used to generate content, to improve content, and the like, where content can include images, audio, video, and the like. The present disclosure contemplates an entirely different modality for diffusion models, namely as use for an unsupervised OOD detector.

At a high-level, diffusion models sample from a distribution by reversing a gradual noising process. In particular, sampling starts with noise x_{T} and produces gradually less-noisy samples x_{T-1}, x_{T-2}, . . . until reaching a final sample x₀. Diffusion models learn to remove the noise in a backward process that was added sequentially in a Markovian fashion during a so-called forward process. These two processes represent the backbone of the diffusion model. For simplicity, we restrict ourselves to an unconditional case and discuss modifications for a condition case below. The forward process is parametrized as:

$$q ( {x}_{1} , … , {x}_{T} \vert {x}_{0} ) = {\prod }_{t = 1}^{T} q ( {x}_{t} \vert {x}_{t - 1} ) \qquad ( 1 )$$

where q(xₜ|xₜ₋₁)= [symbol] (\sqrt{1−βₜ}xₜ₋₁, βₜI) [xₜ] and the (fixed and learnable) forward-process variances βₜ adjust the noise level. Equivalently, xₜ can be expressed in closed form as xₜ=\sqrt{αₜ}x₀+(1−αₜ)ϵ for ϵ˜ [symbol] (0, I) with αₜ=Σᵢ₌₁^{t}−βᵢ. The backward process is parameterized as:

$${p}_{θ} ( {x}_{0} , … , {x}_{t - 1} \vert {x}_{0} ) = p ( {x}_{T} ) {\prod }_{t = 1}^{T} {p}_{θ} ( {x}_{t - 1} \vert {x}_{t} ) \qquad ( 2 )$$

where xₜ˜ [symbol] (0, I), Again, p_{θ}(xₜ₋₁|xₜ) is assumed as normal-distributed (with co-variance matrix) with learnable parameters. Using a particular parameterization of p_{θ}(xₜ₋₁|xₜ), Jonathan Ho, Ajay Jain, and Pieter Abbeel, “Denoising diffusion probabilistic models” In Advances in Neural Information Processing Systems, volume 33, pp. 6840-6851, 2020, the contents of which are incorporated by reference, showed the reverse process can be trained using the following objective:

$$L = {min}_{θ} {𝔼}_{{x}_{0} \sim 𝒟 , {x}_{t} \sim 𝒩 ( 0 , I ) , t \sim 𝒰 ( 1 , T )} {‖ ϵ - {ϵ}_{θ} ( \sqrt{{α}_{t}} {x}_{0} + ( 1 - {α}_{t} ) ϵ , t ) ‖}_{2}^{2} \qquad ( 3 )$$

where [symbol] refers to the data distribution and ϵ_{θ}(xₜ, t) is parameterized using a neural network, which is equivalent to earlier score matching techniques. This objective can be seen as a weighted variational bound on the negative log-likelihood that down-weights the importance of terms at small t, i.e., at small noise levels.

Extending the unconditional diffusion process described so far, one can consider conditional variants where the backward process is conditioned on additional information, i.e., ϵ_{θ}=ϵ_{θ}(xₜ, t, c), where the precise nature of the conditioning information c depends on the application at hand and ranges from global to local information.

### Time Series Imputation

Let x be a data sample with shape [symbol] ^{T×F}, where T represents the number of time steps, and F denotes the number of features or channels. Imputation targets are commonly defined using binary masks that correspond to the shape of the input data, i.e., M∈{0, 1}T×F. In this case, ones indicate the values to be conditioned on, while zeros represent the values to be imputed.

Further, we assume that each time series data point x is accompanied by additional side information, denoted as z∈ [symbol] ^{K}. The side information vector z encapsulates supplementary details about the time series, incorporating domain-specific or auxiliary information related to the task. For example, if the time series represents stock market data, the side information could include the type of stock, historical volatility, and variance relative to other stocks, among other factors.

### Problem Statement

The present disclosure addresses the problem of unsupervised OOD detection for time series data. Time series data is a series of data points (i.e., numerical) in some sequence (i.e., ordered in time). The present disclosure contemplates any type of time series data, including, e.g., network data, medical data, financial data, weather information, financial data, and the like. Assume there is some machine learning model that has been trained with a set of training data and we are going to use this machine learning model on time series data. We are looking at detecting whether or not the time series data is in-distribution or out-of-distribution relative to a target domain associated with the machine learning model. A simple example of out-of-distribution data would be weather data (e.g., temperature) when the machine learning model was trained on stock prices. Here, the target domain is stock price and temperature is clearly in another domain, i.e., OOD. In machine learning, a domain is all the values that can (i.e., that make sense given the context) go into a function. A task (in general) is a piece of work to be done or undertaken (e.g., figuring out the function). The key to OOD detection is to determine the machine learning model will not yield a valuable result if the input is OOD.

For unsupervised OOD detection of a time series domain, given a distribution of interest, [symbol] , that includes time series data, the objective is to formulate an unsupervised OOD detection problem as follows:
Input: a set of unlabeled in-distribution time series samples X=x₁, . . . , xₙ˜ [symbol] , and a test data point x_{Test}.
Output: an OOD score s(x_{Test}), that quantifies the likelihood of x_{Test} not being sampled from [symbol] .

The present disclosure includes a detector that uses the input set X, such that for a given test data point, x, the detector computes an OOD score s(x), where a higher value of s(x) signifies a greater probability that x is not drawn from the distribution [symbol] in the time series domain.

Note, the terms used here are out-of-distribution and in-distribution where the distribution refers to the data set the diffusion model is parameterized on. Other terms may include out-of-domain and in-domain. That is, the terms domain and distribution may be used interchangeably.

### Unsupervised OOD Detection

Again, the present disclosure includes an unsupervised OOD detection process for time series data. The objective of the process is to compute an OOD score s(x_{Test}) for a given test data point x_{Test}, which quantifies the likelihood of x_{Test} not being sampled from the distribution of interest [symbol] .

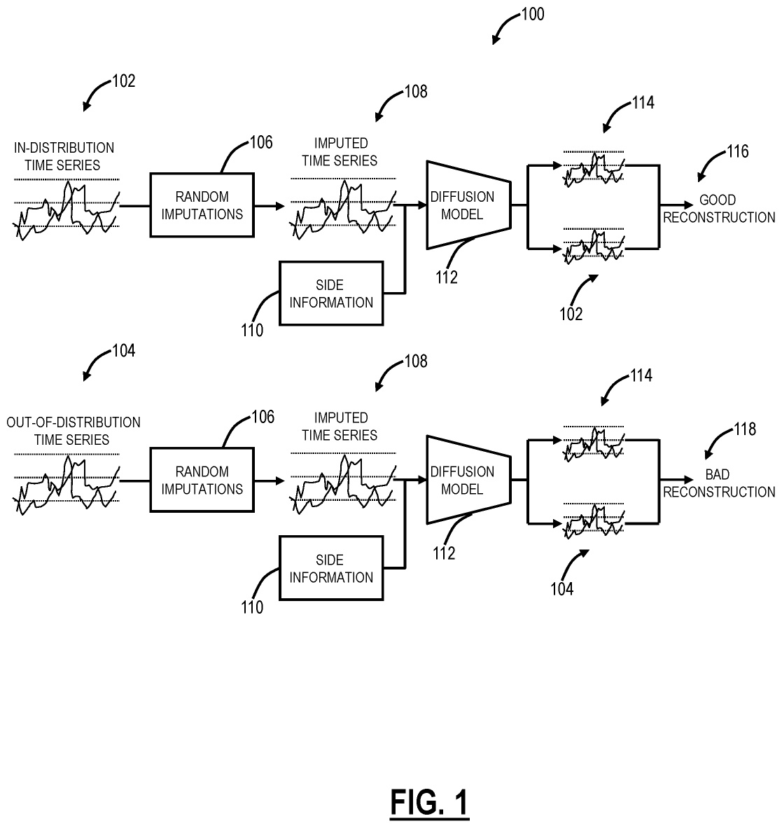

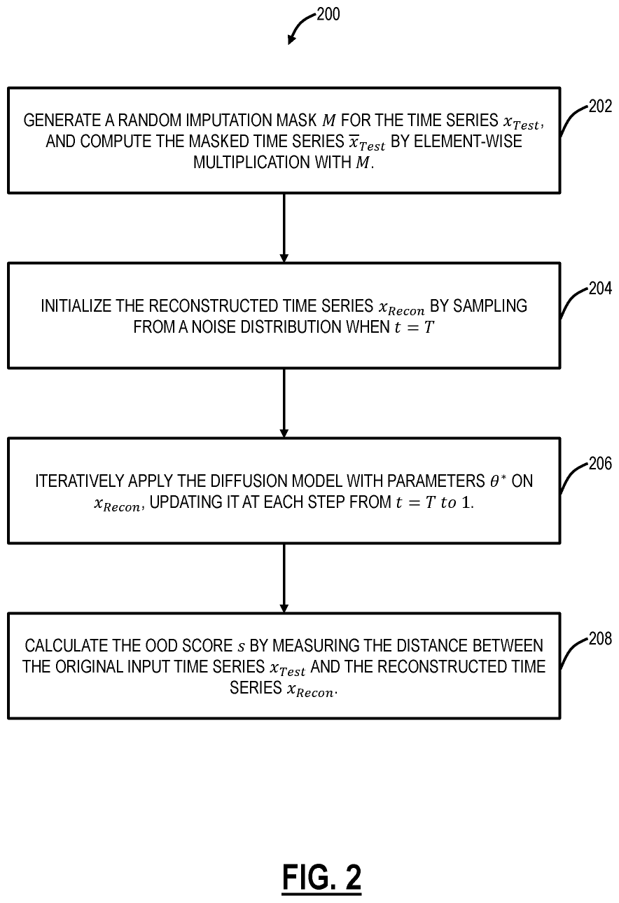

FIG. 1 is a diagram of an unsupervised OOD detection system 100. FIG. 2 is a flowchart of a process 200 for unsupervised OOD detection. The system 100 and the process 200 contemplate implementation as a method having steps, via a processing device configured to implement the steps, via a cloud service configured to implement the steps, and via a non-transitory computer-readable medium storing instructions for programming one or more processors to execute the steps. That is, the unsupervised OOD detection system 100 is a logical view of functionality performed on input time series data 102, 104.

For illustration purposes, FIG. 2 includes two copies of the unsupervised OOD detection system 100 with a top view with in-distribution input time series data 102 and a bottom view with out-of-distribution time series data 104. Besides having the different input time series data 102, 104, the two copies of the unsupervised OOD detection system 100 include the same functions, namely a random imputation function 106 that performs random imputation on the input time series data 102, 104 to form imputed time series data 108.

The imputed time series data 108 and associated side information 110 is input to a diffusion model 112 which provides output time series data 114. At this point, the output time series data 114 is compared to the input time series data 102, 104. If the input time series data 102, 104 is in-distribution, we would expect the output time series data 114 to be a good reconstruction 116 after the diffusion model 112. On the contrary, if the input time series data 104 is out-of-distribution, we would expect the output time series data 114 to be a bad reconstruction 118 after the diffusion model 112. In this manner, the diffusion model 112 can be used to perform unsupervised OOD detection.

The system 100 and the process 200 leverages the diffusion model 112 with optimal parameters θ* to perform OOD detection. The input to the system 100 and the process 200 includes the input time series data 102, 104, which can be referred to as (x_{Test}, z_{Test}), where x_{Test} is the time series data point and z_{Test} is the corresponding side information.

In FIG. 2, the process 200 includes:

At step 202, generate a random imputation mask M for the time series x_{Test}, and compute the masked time series x̅_{Test} by element-wise multiplication with M.

At step 204, initialize the reconstructed time series x_{Recon} by sampling from a noise distribution when t=T.

At step 206, iteratively apply the diffusion model with parameters θ* on x_{Recon}, updating it at each step from t=T to 1.

At step 208, calculate the OOD score s by measuring the distance between the original input time series x_{Test} and the reconstructed time series x_{Recon}.

The output of the process 200 is the OOD score s which indicates the likelihood the input time series data point x_{Test} is out-of-distribution. A higher value of s signifies a greater probability that x_{Test} is not drawn from the distribution [symbol] in the time series domain.

The following provides pseudo code for implementation:

```
Input: test time series (x_{Test},z_{Test}), and
diffusion model (DM) with parameters
θ*.
Generate random imputation mask M for x_{Test}.
x̅_{Test} = M × x_{Test},
for t = T to 1 do
  if == T then
    x_{Recon} ← sample from noise distribution
  end
  x_{Recon} ← DM(x_{Recon},z_{Test},x̅_{Test}, θ*)
end
Calculate OOD score s ← Distance (x_{Test},x_{Recon})
Return s
```

The system 100 and the process 200 utilize processes the test time series data using the diffusion model and the side information. The beginning includes generating a random imputation mask for the test time series and computing the masked test time series. The system 100 and the process 200 then iterate through each time step, initializing the reconstructed time series by sampling the from a noise distribution when t equals T. At each step, it updates the reconstructed time series using the diffusion model with parameters θ*, incorporating the side information and masked test time series. Finally, the system 100 and the process 200 calculate the OOD score by measuring the distance between the original test time series and the reconstructed time series, indicating the likelihood of the test data point being out-of-distribution.

### Diffusion Model and Side Information

The diffusion model is a crucial component and we are using it in a unique manner. The diffusion model is responsible for mapping the time series data points and their side information. The side information vector z_{Test} encapsulates supplementary details about the time series, incorporating domain-specific or auxiliary information related to the task. By incorporating this side information in the system 100 and the process 200, we can better understand the underlying structure of the time series data and improve accuracy of the OOD detection.

### Distance Metric for OOD Score

The choice of a distance metric in calculating the OOD score can be significant in the performance of the system 100 and the process 200. Common distance metrics, such as Euclidean distance or cosine similarity, can be used to measure the dissimilarity between the original test time series x_{Test} and the reconstructed time series x_{Recon}. The choice of the distance metric can be based on the specific characteristics of the time series data and the desired properties of the OOD detection.

### Example Use Cases

In one use case, the approach described herein can be used for anomaly detection of Internet of Things (IoT) data. For experimentation, we used a public data set of 99 network traffic flows from 27 commercial IoT devices. Among the IoT devices, a portion are infected by malware and another portion are clean. Specifically, nine of the 27 devices are infected with the Mirai malware, nide are infected by the BASLITE malware, and 9 devices are clean. For each of the IoT device infected by malware, 10 network traffic flows are collected, where one network traffic flow is related to one type of network attacking launched by the corresponding malware. One network traffic flow is collected for each healthy IoT device. The 27 devices belong to three categories, namely, camera, doorbell, and thermostat. In particular, two devices belong to the doorbell category, one device belongs to the thermostat category, and the remaining devices belong to the camera category. Each data point in a network traffic flow is the feature vector of the corresponding packet. The dimensionality of a feature vector is 115. We label the network traffic flows generated from the infected devices as anomaly, and the traffic flows generated from the clean devices as benign. We treat the device type as the categorical feature of the flow.

We trained the diffusion model on time series data corresponding to the network traffic flows. For example, the in-distribution can be the clean network traffic flows or the malicious network traffic flows. Assume, the diffusion model is trained on the in-distribution data being the clean network traffic flows. With the OOD detection process, we can take unknown time series and determine whether they are in-distribution (likely clean) or out-of-distribution (likely malware). In this manner, the OOD detection process can be used for automatic classification, i.e., whether or not test time series is in-distribution or out-of-distribution, based on the predetermined domains.

In another use case, the approach described herein can be used for Distributed Denial of Service (DDOS) attack detection. Here, we used a dataset that contains a set of benign network traffic flows and a set of DDOS network traffic flows. We treat the DDOS network flows as anomaly network flows. A data point in a network flow is a feature vector of a packet. The dimensionality of a feature vector is 11, where Internet Protocol (IP) flags, protocols, Transmission Control Protocol (TCP) flags, and Internet Control Message Protocol (ICMP) type are categorical features. Here, an unknown test series of network traffic flow can be determined to be benign or DDOS based on whether or not it is in-distribution or out-of-distribution, based on the predetermined domains.

A further use case includes Network Beaconing Sequence Detection.

### Advantages

Thus, one application of the OOD detection is anomaly detection. In conventional approaches for classical anomaly detection, labels are required for OOD data. With our approach, we can learn to detect OOD data points without labeled samples. Our approach achieves this by training a diffusion model to model the in-distribution data.

Diffusion models are state-of-the-art generative models that accurately reconstruct in-distribution data, conditioned on the imputations of the observed data. The key insight in our approach is that the diffusion model has learned to reconstruct in-distribution data correctly and will perform poorly in reconstructing OOD data. As such, we use this insight to build an OOD detector based on the reconstruction error of the diffusion model in reconstructing a data point conditioned on its imputed representation. Additionally, our approach leverages domain-specific side information to provide the diffusion model with additional information for reconstruction. We experimentally demonstrated that this side information helps the diffusion model learn a better data distribution, ultimately leading to a more effective OOD detector.

The present disclosure provides several significant contributions to the field of OOD detection for time series data.
(1) The development of an unsupervised learning approach for OOD detection, leveraging state-of-the-art diffusion models to learn the data distribution. By utilizing conditional sampling for reconstruction and measuring the reconstruction error, we establish an effective OOD detector that does not require labeled data samples. This novel approach demonstrates the potential of diffusion models for unsupervised OOD detection tasks.
(2) The incorporation of domain-specific side information to improve OOD detection performance. By including side information in the learning process, our approach enhances the diffusion model's ability to capture the underlying structure of time-series data, ultimately leading to a more robust OOD detector.
(3) Finally, we experimentally demonstrate the state-of-the-art performance of our proposed approach on three diverse datasets, encompassing a wide range of applications: IoT Event Sequence Detection, DDOS Attack Detection, and Network Beaconing Sequence Detection. These experimental results showcase the effectiveness and versatility of our approach in handling various OOD detection tasks across different domains.

### Process

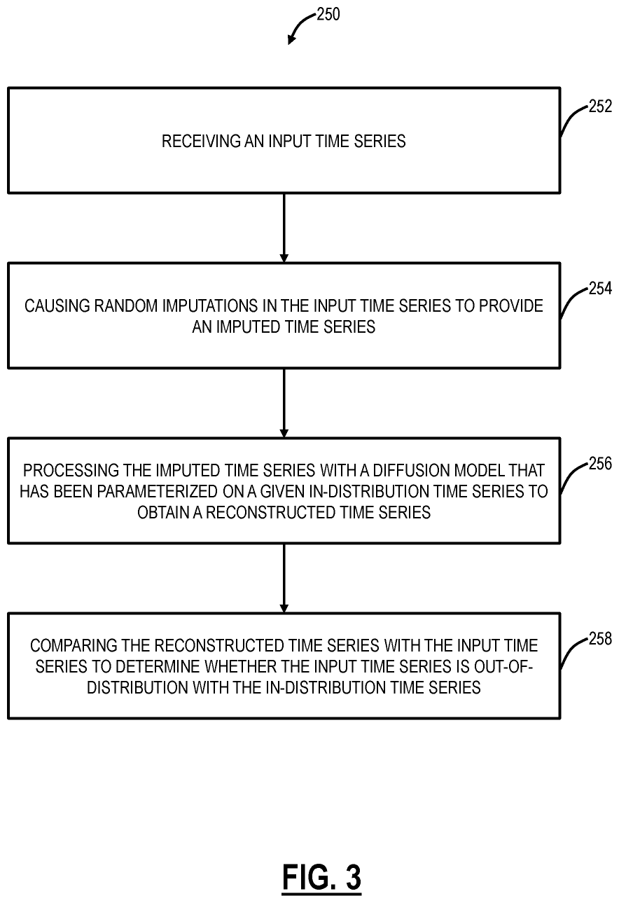

FIG. 3 is a process 250 for using a diffusion machine learning model for out-of-distribution (OOD) detection of time series data. The process 250 contemplates implementation as a method having steps, via a processing device configured to implement the steps, via a cloud service configured to implement the steps, and via a non-transitory computer-readable medium storing instructions for programming one or more processors to execute the steps.

The process 250 includes receiving an input time series, at step 252; causing random imputations in the input time series to provide an imputed time series, at step 254; processing the imputed time series with a diffusion model that has been parameterized on a given in-distribution time series to obtain a reconstructed time series, at step 256; and comparing the reconstructed time series with the input time series to determine whether the input time series is out-of-distribution with the in-distribution time series, at step 258. The comparing can include determining a score based on distance between the reconstructed time series and the input time series, wherein the score is an indicator of a likelihood the input time series is out-of-distribution. The distance can be one of Euclidean distance and cosine similarity.

When the input time series is out-of-distribution, the reconstructed time series is a bad reconstruction relative to when the input time series is in-distribution. The processing step 256 can further include utilizing domain-specific side information with the imputed time series in the diffusion model. The random imputations can be performed using a mask determined based on a number of time steps and a number of features. The process 250 can include training the diffusion model with in-distribution time series data, such that the comparing determines whether or not the input time series belongs to a same distribution as the in-distribution time series data.

The process 250 can include classifying the input time series based on the comparing such that (1) when the input time series is in-distribution, the input time series is classified as belonging to a domain associated with the in-distribution time series, and (2) when the input time series is out-of-distribution, the input time series is classified as not belonging to the domain. The process 250 can include determining whether the input time series is anomalous Internet of Things (IoT) communications based on the comparing. The process 250 can include determining whether the input time series corresponds to a Distributed Denial of Service (DDoS) network flow based on the comparing.

### Processing System

FIG. 3 is a block diagram of a processing system 300, which may implement aspects of the system 100 and the processes 200, 250. The processing system 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 3 depicts the processing system 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example, but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a Central Processing Unit (CPU), an auxiliary processor among several processors associated with the processing system 300, a semiconductor-based microprocessor (in the form of a microchip or chipset), or generally any device for executing software instructions. When the processing system 300 is in operation, the processor 302 is configured to execute software stored within the memory 310, to communicate data to and from the memory 310, and to generally control operations of the processing system 300 pursuant to the software instructions. The I/O interfaces 304 may be used to receive user input from and/or for providing system output to one or more devices or components.

The network interface 306 may be used to enable the processing system 300 to communicate on a network, such as the Internet. The network interface 306 may include, for example, an Ethernet card or adapter or a Wireless Local Area Network (WLAN) card or adapter. The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 308 may incorporate electronic, magnetic, optical, and/or other types of storage media. In one example, the data store 208 may be located internal to the processing system 300, such as, for example, an internal hard drive connected to the local interface 312 in the processing system 300. Additionally, in another embodiment, the data store 308 may be located external to the processing system 300 such as, for example, an external hard drive connected to the I/O interfaces 204 (e.g., SCSI or USB connection). In a further embodiment, the data store 208 may be connected to the processing system 300 through a network, such as, for example, a network-attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 may include one or more software programs, each of which includes an ordered listing of executable instructions for implementing logical functions. The software in the memory 310 includes a suitable Operating System (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

Of note, the general architecture of the processing system 300 can define any device described herein. However, the processing system 300 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.” In addition to the cloud, the processing system 300, and the like, the various techniques described herein can be implemented in a router, switch, firewall, security appliance, or the like.

### CONCLUSION

The output of the OOD detection is a determination of whether or not the input time series is in-distribution or out-of-distribution. Those skilled in the art will appreciate this output can be used in various practical applications. For example, in network security, with IoT, DDOS, etc., a network traffic flow can be classified and appropriate security measures or functions implemented accordingly. In a general use case, in addition to using the OOD detection as a classifier, when input time series is OOD, one can disregard any output from another machine learning model that was trained on in-distribution data. Further, the present disclosure provides a unique and new use case for diffusion models. Of note, diffusion models have generally been used as generative models, e.g., to generate content (video, audio, images, etc.). The present disclosure utilizes them to reconstruct time series to see if the reconstruction is good or bad and, in this manner, supports an OOD detection based on the reconstruction. That is, we are not using the diffusion model to generate something new, but rather to see if what it generates after a time series is randomly imputed is good/bad to determine OOD detection.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A method comprising steps of:
receiving an input time series;
causing random imputations in the input time series to provide an imputed time series;
processing the imputed time series with a diffusion model that has been parameterized on a given in-distribution time series to obtain a reconstructed time series; and
comparing the reconstructed time series with the input time series to determine whether the input time series is out-of-distribution with the in-distribution time series.

2. The method of claim 1, wherein the comparing includes determining a score based on distance between the reconstructed time series and the input time series, wherein the score is an indicator of a likelihood the input time series is out-of-distribution.

3. The method of claim 2, wherein the distance is one of Euclidean distance and cosine similarity.

4. The method of claim 1, wherein, when the input time series is out-of-distribution, the reconstructed time series is a bad reconstruction relative to when the input time series is in-distribution.

5. The method of claim 1, wherein the processing further includes:
utilizing domain-specific side information with the imputed time series in the diffusion model.

6. The method of claim 1, wherein the random imputations are performed using a mask determined based on a number of time steps and a number of features.

7. The method of claim 1, wherein the steps further include:
training the diffusion model with in-distribution time series data, such that the comparing determines whether or not the input time series belongs to a same distribution as the in-distribution time series data.

8. The method of claim 1, wherein the steps further include:
classifying the input time series based on the comparing such that (1) when the input time series is in-distribution, the input time series is classified as belonging to a domain associated with the in-distribution time series, and (2) when the input time series is out-of-distribution, the input time series is classified as not belonging to the domain.

9. The method of claim 1, wherein the steps further include:
determining whether the input time series is anomalous Internet of Things (IoT) communications based on the comparing.

10. The method of claim 1, wherein the steps further include:
determining whether the input time series corresponds to a Distributed Denial of Service (DDoS) network flow based on the comparing.

11. A non-transitory computer-readable medium comprising instructions that, when executed, cause one or more processors to perform steps of:
receiving an input time series;
causing random imputations in the input time series to provide an imputed time series;
processing the imputed time series with a diffusion model that has been parameterized on a given in-distribution time series to obtain a reconstructed time series; and
comparing the reconstructed time series with the input time series to determine whether the input time series is out-of-distribution with the in-distribution time series.

12. The non-transitory computer-readable medium of claim 11, wherein the comparing includes determining a score based on distance between the reconstructed time series and the input time series, wherein the score is an indicator of a likelihood the input time series is out-of-distribution.

13. The non-transitory computer-readable medium of claim 12, wherein the distance is one of Euclidean distance and cosine similarity.

14. The non-transitory computer-readable medium of claim 11, wherein, when the input time series is out-of-distribution, the reconstructed time series is a bad reconstruction relative to when the input time series is in-distribution.

15. The non-transitory computer-readable medium of claim 11, wherein the processing further includes:
utilizing domain-specific side information with the imputed time series in the diffusion model.

16. The non-transitory computer-readable medium of claim 11, wherein the random imputations are performed using a mask determined based on a number of time steps and a number of features.

17. The non-transitory computer-readable medium of claim 11, wherein the steps further include:
training the diffusion model with in-distribution time series data, such that the comparing determines whether or not the input time series belongs to a same distribution as the in-distribution time series data.

18. The non-transitory computer-readable medium of claim 11, wherein the steps further include:
classifying the input time series based on the comparing such that (1) when the input time series is in-distribution, the input time series is classified as belonging to a domain associated with the in-distribution time series, and (2) when the input time series is out-of-distribution, the input time series is classified as not belonging to the domain.

19. The non-transitory computer-readable medium of claim 11, wherein the steps further include:
determining whether the input time series is anomalous Internet of Things (IoT) communications based on the comparing.

20. The non-transitory computer-readable medium of claim 11, wherein the steps further include:
determining whether the input time series corresponds to a Distributed Denial of Service (DDoS) network flow based on the comparing.
